(19) United States
(12) Patent Application Publication
(10) Pub. No.: US 2006/0044598 A1
(43) Pub. Date: Mar. 2, 2006

(54) Wireless-based location-aware remote printing

(75) Inventor: Esa Etelapera, Tampere (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation, Espoo (FI)

(21) Appl. No.: 10/933,680

(22) Filed: Sep. 2, 2004

(51) Int. Cl. G06F 15/00

(52) U.S. Cl. 358/1.15

(57) ABSTRACT

This invention describes a method for remote printing a file sent to a mobile device (e.g., a wireless electronic device, a mobile communication device or a mobile phone) using a wireless mechanism. The invention describes identifying a remote printer closest to a location of the mobile device with the required capabilities for printing the file using a printer system (e.g. a server, a network element of a wireless communication system, etc.). Another important issue resolved by the present invention is providing a required minimum level of security for the remote printing which can be requested by a user of said mobile device.

### TECHNICAL FIELD

This invention generally relates to mobile devices and more specifically to remote printing a file sent to a mobile device using a wireless mechanism.

### BACKGROUND ART

Mobile devices are capable of receiving e-mails containing documents in various formats. However, capabilities to print (or even view) those documents may be limited. Even if the printing capabilities exist, finding the nearest printer to use in a large office area might be difficult. Furthermore, configuring the device to use the found printer for printing may be challenging.

Therefore, it is important to be able to use wireless methods (e.g., e-mail, short message service, etc.) for printing a file sent to a mobile device (e.g., a wireless electronic device, a mobile communication device, a mobile phone, etc.). A problem yet to be resolved while using this wireless approach is finding a remote printer closest to a location of the mobile device with the required capabilities for printing the file. Another important issue is providing a required minimum level of security for the remote printing which can be requested by a user of the mobile device.

### DISCLOSURE OF THE INVENTION

The object of the present invention is to provide a methodology for remote printing a file sent to a mobile device using a wireless mechanism.

According to a first aspect of the invention, a method for remote printing a file sent to a mobile device, comprises the steps of: providing information containing said file, optionally a location of said mobile device and optionally a minimum required security level for said remote printing to a printing system by a wireless mechanism; determining a remote printer closest to the location of the mobile device by the printing system, the remote printer is capable of printing the file and also capable of providing the minimum required security level if the minimum required security level is provided to the printing system, wherein the location is determined by the printing system based on the information if the information does not contain the location; and printing the file on the remote printer by the printing system, wherein the remote printer is one of M remote printers capable of the remote printing by the printing system and M is an integer of at least a value of one.

According further to the first aspect of the invention the minimum required security level may be determined by the printing system based on the information if the information does not contain the minimum required security level,.

Further according to the first aspect of the invention, the information may be provided by the mobile device requesting the remote printing. Further, the location is added manually by a user of the mobile device requesting the remote printing.

Still further according to the first aspect of the invention, the step of determining the remote printer may be provided by using a printer location database of the printing system.

According further to the first aspect of the invention, the printer location database may contain printer specific capabilities, printer locations and printer security levels regarding the M remote printers. Still further, the file provided to the printing system may be stored in a file storage area of the printing system.

According still further to the first aspect of the invention, before the printing, the file from the file storage area may be provided to an appropriate application directory which opens the file and sends it to the remote printer for the printing, wherein the appropriate application directory is one of N application directories contained in the printing system, wherein N is an integer of at least a value of one.

According further still to the first aspect of the invention, after the printing, the remote printer may send to the printing system a print status signal indicating a success or a failure of the printing, and the printing system forwards the print status signal and a printer location of the remote printer to the mobile device.

According yet further still to the first aspect of the invention, the file may be provided to the remote printer for the printing by the printer system using a wireless communication. Further, the printing system may be a server or a network element of a wireless communication system, or the printing system is a printing service hosted by a system operator.

Yet still further according to the first aspect of the invention, the step of providing the information may comprise of: sending or forwarding from a remotely located inbox to printing system by the mobile device a message signal containing the file for the remote printing, optionally containing the location of the mobile device and optionally containing the minimum required security level. Further, the step of providing the information, if the location of the mobile device or the minimum required security level is not contained in the message signal, may further comprise: sending to the mobile device by the printing system in response to the message signal a location/security request signal requesting the location of the mobile device, if the location of the mobile device is not contained in the message signal, and requesting the minimum required security level, if the minimum required security level is not contained in the message signal; and sending to the printing system by the mobile device in response to the location/security request signal a location/security signal containing the location of the mobile device if requested by the location/security request signal and optionally containing the minimum required security level if requested by the location/security request signal. Still further, the message signal may be received by a communication block of the printing system, the location/security request signal may be sent by the communication block and the location/security signal may be received by the communication block. Yet still further, after completing the step of providing the information, the method may comprise the step of: sending to a file storage area by the communication block a file signal containing the file of the printing system, and sending to a print operator of the printing system by the communication block a print information signal containing the location of the mobile device, a type of the file, an ID of the file and optionally the minimum required security level. Yet further still, the step of determining the remote printer may be performed by the print operator using the print information signal and by communicating with a printer location database of the printing system, wherein the printer location database contains printer specific capabilities, printer locations and printer security levels regarding the M remote printers. Further still, before the printing, the method may comprise the steps of: providing by the print operator to an appropriate application directory which is capable of opening the file a print request signal containing the ID of the file and an address of the remote printer; and taking the file from the file storage area by the appropriate application directory, opening the file by the appropriate application directory and sending the file by the appropriate application directory to the remote printer for the printing, wherein the appropriate application directory is one of the N application directories contained in the printing system, wherein N is an integer of at least a value of one. Still yet further, after the printing, the remote printer may send to the print operator a print status signal indicating a success or a failure of the printing and the print operator may forward the print status signal and a printer location of the remote printer to the mobile device.

Still yet further according to the first aspect of the invention, the mobile device may be a wireless electronic device, a mobile communication device or a mobile phone.

According to a second aspect of the invention, a computer program product comprises: a computer readable storage structure embodying computer program code thereon for execution by a computer processor with the computer program code characterized in that it includes instructions for performing the steps of the first aspect of the invention indicated as being performed by any component or a combination of components of the printing system or the mobile device or both the printing system and the mobile device.

According to a third aspect of the invention, a printing system for wireless printing of a file sent to a mobile device, comprises: means for receiving information containing said file, optionally a location of said mobile device and optionally a minimum required security level for said remote printing from said mobile device by a wireless mechanism; means for determining a remote printer closest to said location of said mobile device, said remote printer is capable of printing said file and also capable of providing said minimum required security level if said minimum required security level is provided, wherein said location is determined by said printing system based on said information if said information does not contain said location; and means for printing the file on the remote printer by the printing system, wherein the remote printer is one of M remote printers capable of the remote printing by the printing system and M is an integer of at least a value of one.

According further to the third aspect of the invention, the minimum required security level may be determined by the printing system based on the information if the information does not contain the minimum required security level.

Further according to the third aspect of the invention, the information may be provided by the mobile device requesting the remote printing. Further, the location may be added manually by a user of the mobile device requesting the remote printing.

Still further according to the third aspect of the invention, the means for determining a remote printer closest to the location of the mobile device may contain a printer location database. Still further, the printer location database may contain printer specific capabilities, printer locations and printer security levels regarding the M remote printers.

According further to the third aspect of the invention, the printing system may further comprise a file storage area, for storing the file provided to the printing system.

According still further to the third aspect of the invention, before the printing by the means for printing the file on the remote printer, the file from the file storage area may be provided to an appropriate application directory which opens the file and sends it to the remote printer for the printing, wherein the appropriate application directory is one of N application directories contained in the printing system, wherein N is an integer of at least a value of one.

According yet further still to the third aspect of the invention, after the printing by the means for printing the file on the remote printer, the remote printer sends to the printing system a print status signal indicating a success or a failure of the printing and the printing system forwards the print status signal and a printer location of the remote printer to the mobile device.

According further still to the third aspect of the invention, the file may be provided to the remote printer for the printing by the printer system using a wireless communication. Still further, the printing system may be a server or a network element of a wireless communication system, or the printing system may be a printing service hosted by a system operator.

Yet still further according to the third aspect of the invention, the information may be provided by sending or forwarding from a remotely located inbox to the means for receiving of the printing system by the mobile device a message signal containing the file for the remote printing, optionally containing the location of the mobile device and optionally containing the minimum required security level.

Still yet further according to the third aspect of the invention, if the location of the mobile device or the minimum required security level is not contained in the message signal, the means for receiving of the printing system may send to the mobile device in response to the message signal a location/security request signal requesting the location of the mobile device if the location of the mobile device is not contained in the message signal, and requesting the minimum required security level if the minimum required security level is not contained in the message signal, and, in response to the location/security request signal, the mobile device may send to the means for receiving of the printing system a location/security signal containing the location of the mobile device if requested by the location/security request signal and optionally containing the minimum required security level if requested by the location/security request signal. Further, the means for receiving of the printing system may be a communication block of the printing system. Still further, using the information received by the information block, the communication block may send a file signal containing the file to a file storage area of the printing system and may send a print information signal containing the location of the mobile device, a type of the file, an ID of the file and optionally the minimum required security level to a print operator of the printing system. Further still, the means for determining a remote printer may contain the print operator, responsive to the print information signal and a printer location database of the printing system communicating with the print operator, wherein the printer location database may contain printer specific capabilities, printer locations and printer security levels regarding the M remote printers. Yet still further, the print operator may provide to an appropriate application directory, which is capable of opening the file, a print request signal containing the ID of the file and an address of the remote printer, wherein the appropriate application directory may take the file from the file storage area, opens the file and sends the file to the remote printer for the printing, wherein the appropriate application directory is one of the N application directories contained in the printing system, wherein N is an integer of at least a value of one. Yet further still, after the printing, the remote printer may send to the print operator a print status signal indicating a success or a failure of the printing and the print operator forwards the print status signal and a printer location of the remote printer to the mobile device.

Yet further still according to the third aspect of the invention, the mobile device may be a wireless electronic device, a mobile communication device or a mobile phone.

According to a fourth aspect of the invention, a wireless system for remote printing a file comprises of: at least one mobile device to which the file is sent, for providing by a wireless mechanism information containing the file, optionally a location of the at least one mobile device and optionally a minimum required security level for the remote printing; a printing system, responsive to the information sent by the wireless mechanism, for determining a remote printer closest to the location of the at least one mobile device, the remote printer is capable of printing the file and also capable of providing the minimum required security level if the minimum required security level is provided to the printing system, wherein the location is determined by the printing system based on the information if the information does not contain the location; and M remote printers, capable of the remote printing by the printing system, wherein the remote printer is one of the M remote printers and M is an integer of at least a value of one.

According further to the fourth aspect of the invention the minimum required security level may be determined by the printing system based on the information if the information does not contain the minimum required security level.

Further according to the fourth aspect of the invention, the information may be provided by the mobile device requesting the remote printing.

Still further according to the fourth aspect of the invention, the location may be added manually by a user of the mobile device requesting the remote printing.

### BRIEF DESCRIPTION OF THE DRAWINGS

For a better understanding of the nature and objects of the present invention, reference is made to the following detailed description taken in conjunction with the following drawings, in which:

FIG. 1 shows a block diagram for remote printing a file sent to a mobile device, according to the present invention; and

FIG. 2 shows a flow chart for remote printing a file sent to a mobile device, according to the present invention.

### BEST MODE FOR CARRYING OUT THE INVENTION

The present invention provides a new methodology for remote printing a file sent to a mobile device (e.g., a wireless electronic device, a mobile communication device or a mobile phone) using a wireless mechanism.

The invention describes identifying a remote printer closest to a location of the mobile device with the required capabilities for printing the file using a printer system (e.g., a server, a network element of a wireless communication system, etc.). Another important issue resolved by the present invention is providing a required minimum level of security for the remote printing which can be requested by a user of said mobile device.

According to the present invention, a mobile device receives an e-mail containing attached documents a user wants to print. The user forwards the received e-mail to a special e-mail address, e.g., print@nokia.com. The forwarded e-mail may include the current location of the mobile device. The system which receives the e-mail sent to this special e-mail address records a sender location either using the included location information or by using location query services asking the current location of the mobile device. The system then locates, from its database, the printer closest to the mobile device. The system opens the received attachment documents using corresponding (e.g., window) applications and asks those applications to print those documents to the specified printer. When the printing process is completed, the system notifies the user (e.g. via e-mail or short message service) about the completed task along with information about the location where the print-out can be found.

Moreover, according to the present invention, the remote printers listed on a system database can provide a certain security level assigned to them based on printer's location (e.g., a printer is in a public location, a printer is in a confidential R&D location, a printer is in a top-secret management location, etc.). The user sending the print request may require in his/her request a certain minimum security level for the print-out location. The system then locates, from its database, the printer closest to the mobile device but also capable of supporting said minimum requested level of security.

This invention can be utilized also in an environment where, e.g., a special system operator can host the printing service. Furthermore, the mobile device location information can be added manually by the user to the e-mail requesting printing service (e.g. in a form “room H6B356”, “hermia 5 cafeteria”).

The implementation of this invention is based on the following features:
the user is able to receive his/her e-mails and forward them further or the user is able to see the content of his/her e-mail account “inbox” remotely and forward messages from that “inbox” remotely;
the mobile device can be able to report its location using the e-mail or the mobile device can be able to respond with its location data when requested by a “printing system” or it can be possible for the user of the mobile device to add the location information manually, wherein the user can add the location information when sending the print request or alternatively, the user can utilize a GPS location system available in the requesting mobile device for determining the coordinates that the user adds to the printing request;
the “printing system” can determine the approximate mobile device location by itself if necessary (if the mobile device cannot determine its location by itself); in this case, for example, two possible implementation scenarios can include but not be limited to:
using a BT (bluetooth) or a RFID (radio frequency identification) sensor interlinked to the “printing system”: these sensors can detect if the requesting mobile device is nearby, then there should be some kind of identification data included in the printing request from the mobile device, so that the mobile device is identified when the BT or RFID sensors are trying to detect the mobile device location;
locating the mobile device by using a service provided by an operator, i.e., the printing service is able to locate the mobile device by using a service provided by an operator (e.g., an operator's chargeable service) and using operator approved/sponsored devices having determining location capabilities;
the “printing system” must have a database of printer locations;
the “printing system” must be able to pass the attached documents to the corresponding applications capable of printing them to the appropriate printers; and
the “printing system” must be able to send a printing notification message (e.g., email, short message service) to the user who is requesting the printing service.

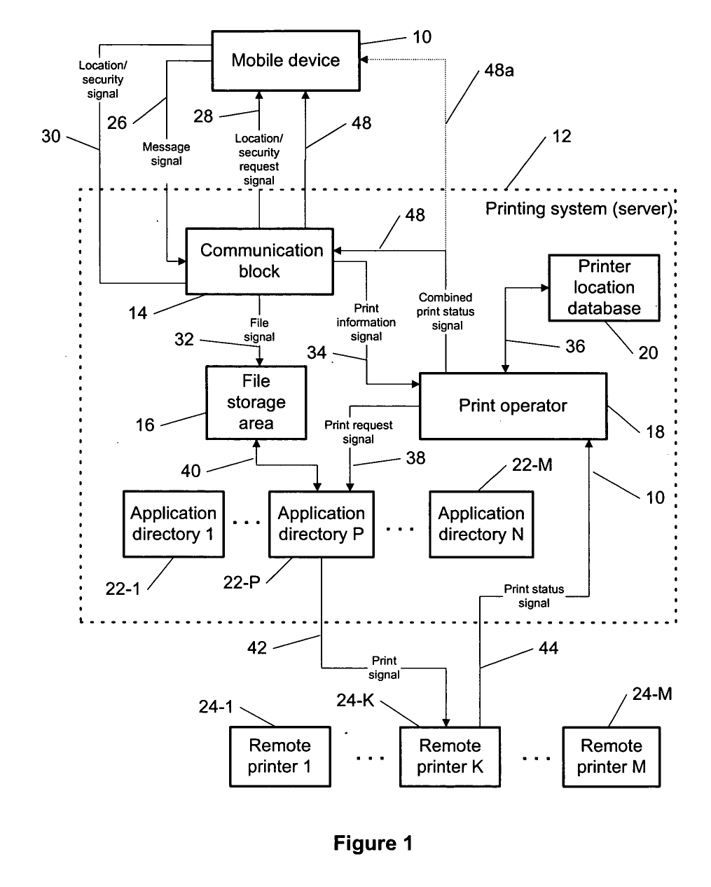

FIG. 1 shows one example among many other possible scenarios of a block diagram for remote printing a file sent to a mobile device 10 (e.g., a wireless electronic device, a mobile communication device or a mobile phone), according to the present invention.

The mobile device 10 sends or forwards from a remotely located inbox to a communication block 14 of a printing system 12 a message signal 26 containing said file for said remote printing, optionally containing a location of the mobile device 10 and optionally containing a minimum required security level for printing said file. If the location of said mobile device 10 or the minimum required security level is not contained in said message signal 26, the communication block 14 of said printing system 12 sends to the mobile device 10 a location/security request signal 28 requesting the location of the mobile device 10, if said location of the mobile device 10 is not contained in the message signal 26, and/or requesting said minimum required security level, if said minimum required security level is not contained in said message signal 26. In response to the location/security request signal 28, the mobile device 10 sends to the communication block 14 a location/security signal 30 preferably containing the location of the mobile device 10 if requested by the location/security request signal 28, and optionally containing the minimum required security level again, if requested by the location/security request signal 28.

Moreover, using the information contained in the signals 26 and 30 (if the signal 30 was needed), the information block 14 sends a file signal 32 containing the file (to be printed) to a file storage area 16 of said printing system 12 and sends a print information signal 34 containing the location (if provided) of the mobile device 10, a type of the file, an ID of the file and said minimum required security level (if provided) to a print operator 18 of said printing system 12.

The print operator 18, in response to the print information signal 34, determines a remote printer (e.g. a remote printer 24-K) closest to the location of the mobile device 10, wherein the remote printer 24-K is capable of printing the file and also capable of providing said minimum required security level (if said minimum required security level is provided to the printing system 12) by communicating with a printer location database 20 of said printing system 12. In that regard, the remote printer 24-K is not necessarily physically the closest printer to the mobile device 10, but the “closest” in a sense of being a printer which can provide the specified minimum security level. The printer location database 20 in a preferred embodiment of the present invention contains printer specific capabilities, printer locations and printer security levels regarding M remote printers 24-1, . . . 24-K, . . . 24-M, wherein M in an integer of at least a value of one.

According to the present invention, there are a number of variations to the procedure described above. For example, if the signals 26, 30, or 34 do not contain the location of the mobile device 10 and/or the minimum required security level, this location of the mobile device 10 and/or this minimum required security level can be determined (maybe less accurately) by the printing system 12 based on the relevant information contained in the signals 26, 30 and 34. Also, if the location of the mobile device 10 is not provided in the signals 26 and/or 30, the location of the mobile device 10 can be added manually by a user of the mobile device 10 requesting said remote printing.

Yet another possibility, according to the present invention, is that the print operator 18 can identify several alternative remote printers out of said M remote printers 24-1, . . . 24-K, . . . 24-M, which can have approximately the same distance to the mobile device and provide the minimum required security level. In this situation, the print operator can make a decision by itself (using, e.g., a certain predefined criteria) or send an additional request to the mobile device 10 asking which remote printer is preferred out of these several alternative remote printers. According to the present invention, upon such a request, the mobile device 10 can answer, e.g., that a printer A (one printer out of said M remote printers 24-1, . . . 24-K, . . . 24-M) shall be used now and always when the printer A is the only one option to carry out the printing request.

Furthermore, the print operator 18 provides a print request signal 38 containing said ID of said file and an address of said remote printer 24-K to an appropriate application directory 22-P which is capable of opening said file. The appropriate application directory 22-P is one of the N application directories contained in said printing system 12, wherein N is an integer of at least a value of one. Then in response to the print request signal 38, the appropriate application directory 22-P takes the file from the file storage area 16, opens the file and sends it to the remote printer 24-K for said printing.

After printing the file, the remote printer 24-K sends to the print operator 18 a print status signal 44 indicating a success or a failure of said printing. Then the print operator 18 preferably forwards a combined print status signal 48 containing the status information of the print status signal 44 and the remote printer 24-K location through the communication block 14 (or alternatively directly using signal 48a) to the mobile device 10.

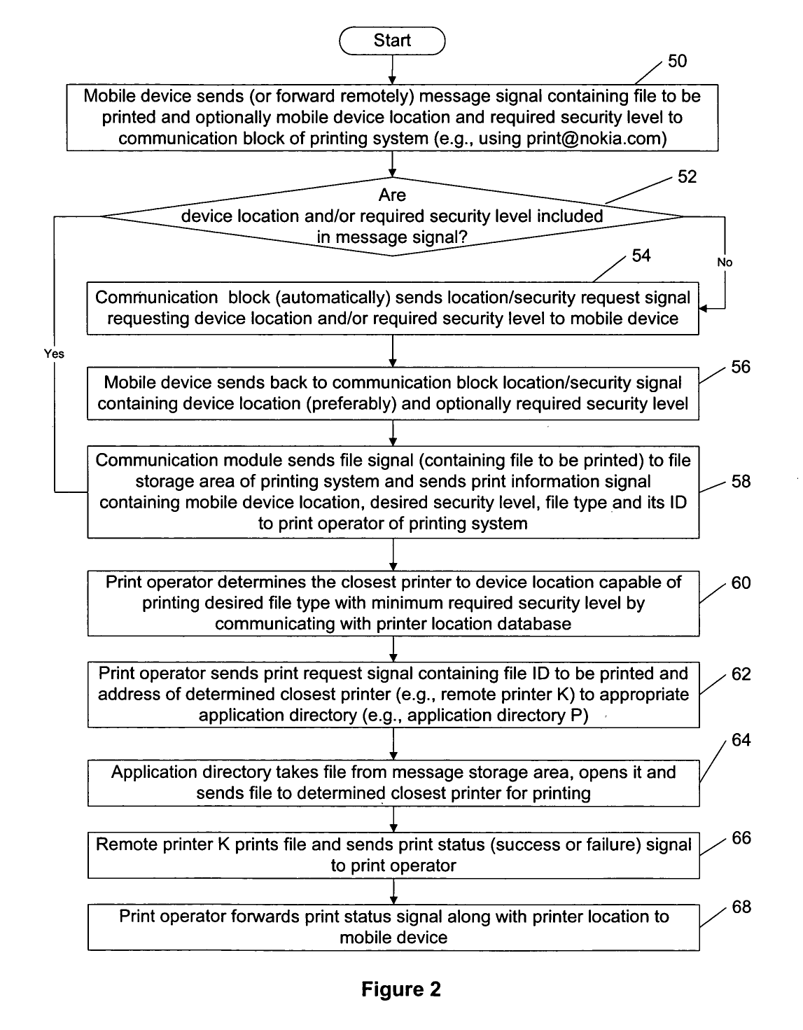

FIG. 2 shows a flow chart for the remote printing the file sent to the mobile device 10, according to the present invention.

The flow chart of FIG. 2 only represents one possible scenario among many others. In a method according to the present invention, in a first step 50, the mobile device 10 sends or forwards from the remotely located inbox to the communication block 14 of the printing system 12 the message signal 26 containing said file for said remote printing, optionally containing a location of the mobile device 10 and optionally containing the minimum required security level for printing the file. In a next step 52, it is determined by the communication block 14 whether the location of the mobile device 10 and/or the minimum required security level are contained in the message signal 26. If that is the case, the process goes to step 58. However, if it is determined by the communication block 14 that the location of the mobile device 10 and/or the minimum required security level are not contained in the message signal 26, in a next step 54, the communication block 14 sends to the mobile device 10, in response to the message signal 26, the location/security request signal 28 requesting the location of the mobile device 10, if said location of the mobile device 10 is not contained in the message signal 26, and requesting said minimum required security level, if said minimum required security level is not contained in said message signal 26. In a next step 56, the mobile device 10, in response to the location/security request signal 28, sends to the communication block 14 the location/security signal 30 preferably containing the location of the mobile device 10 if requested by the location/security request signal 28 and optionally containing the minimum required security level again if requested by the location/security request signal 28.

In a next step 58, the information block 14, using the information contained in the signals 26 and 30 (if the signal 30 was needed), sends the file signal 32 containing said file to the file storage area 16 of said printing system 12 and sends the print information signal 34 containing the location of the mobile device 10, a type of the file, an ID of the file and said minimum required security level (if provided) to the print operator 18 of said printing system 12. In a next step 60, the print operator 18 determines the remote printer (e.g. a remote printer 24-K) closest to the location of the mobile device 10, wherein said remote printer 24-K is capable of printing the file and also capable of providing said minimum required security level (if said minimum required security level is known by said printing system 12) by communicating with a printer location database 20 (containing the printer specific capabilities, the printer locations and the printer security levels regarding said M remote printers 24-1, . . . 24-K, . . . 24-M) of said printing system 12.

In a next step 62, the print operator 18 provides the print request signal 38 containing the ID of said file and the address of said remote printer 24-K to an appropriate application directory 22-P which is capable of opening said file (the appropriate application directory 22-P is one of the N application directories contained in said printing system 12, wherein N is an integer of at least a value of one). In a next step 64, the appropriate application directory 22-P takes the file from the file storage area 16 and opens said file and sends it to the remote printer 24-K for said printing. In a next step 66, the remote printer 24-K after printing the file sends to the print operator 18 the print status signal 44 indicating the success or the failure of said printing. Finally in a next step 68, the print operator 18 forwards a combined print status signal 48 containing the status information of the print status signal 44 and the remote printer 24-K location through the communication block 14 (or alternatively directly using signal 48a) to the mobile device 10.

It is noted that, if there is no security level mentioned in the printing request (signal 26), the lack of it will not necessarily create an inquiry made by the printing system 12 to the sender (the mobile device 10) of the printing request, but it can depend on settings made by an IT-Manager: e.g., there can be a default security level set.

What is claimed is:

1. A method for remote printing a file sent to a mobile device, comprising the steps of:
providing information containing said file, optionally a location of said mobile device and optionally a minimum required security level for said remote printing to a printing system by a wireless mechanism;
determining a remote printer closest to said location of said mobile device by said printing system, said remote printer is capable of printing said file and also capable of providing said minimum required security level if said minimum required security level is provided to said printing system, wherein said location is determined by said printing system based on said information if said information does not contain said location; and
printing said file on said remote printer by said printing system, wherein said remote printer is one of M remote printers capable of said remote printing by said printing system and M is an integer of at least a value of one.

2. The method of claim 1, wherein said minimum required security level is determined by said printing system based on said information if said information does not contain said minimum required security level.

3. The method of claim 1, wherein said information is provided by said mobile device requesting said remote printing.

4. The method of claim 1, wherein said location is added manually by a user of said mobile device requesting said remote printing.

5. The method of claim 1, wherein said step of determining said remote printer is provided by using a printer location database of said printing system.

6. The method of claim 5, wherein said printer location database contains printer specific capabilities, printer locations and printer security levels regarding said M remote printers.

7. The method of claim 1, wherein said file provided to said printing system is stored in a file storage area of said printing system.

8. The method of claim 1, wherein before said printing, said file from the file storage area is provided to an appropriate application directory which opens said file and sends it to said remote printer for said printing, wherein said appropriate application directory is one of N application directories contained in said printing system, wherein N is an integer of at least a value of one.

9. The method of claim 1, wherein, after said printing, said remote printer sends to said printing system a print status signal indicating a success or a failure of said printing, and said printing system forwards said print status signal and a printer location of said remote printer to said mobile device.

10. The method of claim 1, wherein said file is provided to said remote printer for said printing by said printer system using a wireless communication.

11. The method of claim 1, wherein said printing system is a server or a network element of a wireless communication system, or said printing system is a printing service hosted by a system operator.

12. The method of claim 1, wherein said step of providing said information comprises of:
sending or forwarding from a remotely located inbox to printing system by said mobile device a message signal containing said file for said remote printing, optionally containing said location of said mobile device and optionally containing said minimum required security level.

13. The method of claim 12, wherein said step of providing said information, if said location of said mobile device or said minimum required security level is not contained in said message signal, further comprises:
sending to said mobile device by said printing system in response to said message signal a location/security request signal requesting said location of said mobile device, if said location of said mobile device is not contained in said message signal, and requesting said minimum required security level, if said minimum required security level is not contained in said message signal; and
sending to said printing system by said mobile device in response to said location/security request signal a location/security signal containing said location of said mobile device if requested by said location/security request signal and optionally containing said minimum required security level if requested by said location/security request signal.

14. The method of claim 13, wherein said message signal is received by a communication block of the printing system, said location/security request signal is sent by said communication block and said location/security signal is received by said communication block.

15. The method of claim 14, wherein after completing said step of providing said information, the method comprises the step of:
sending to a file storage area by said communication block a file signal containing said file of said printing system, and sending to a print operator of said printing system by said communication block a print information signal containing said location of said mobile device, a type of said file, an ID of said file and optionally said minimum required security level.

16. The method of claim 15, wherein said step of determining said remote printer is performed by said print operator using said print information signal and by communicating with a printer location database of said printing system, wherein said printer location database contains printer specific capabilities, printer locations and printer security levels regarding said M remote printers.

17. The method of claim 16, wherein, before said printing, the method comprises the steps of:
providing by said print operator to an appropriate application directory which is capable of opening said file a print request signal containing said ID of said file and an address of said remote printer; and
taking said file from the file storage area by the appropriate application directory, opening said file by said appropriate application directory and sending said file by said appropriate application directory to said remote printer for said printing, wherein said appropriate application directory is one of the N application directories contained in said printing system, wherein N is an integer of at least a value of one.

18. The method of claim 17, wherein after said printing, said remote printer sends to said print operator a print status signal indicating a success or a failure of said printing and said print operator forwards said print status signal and a printer location of said remote printer to said mobile device.

19. The method of claim 1, wherein said mobile device is a wireless electronic device, a mobile communication device or a mobile phone.

20. A computer program product comprising: a computer readable storage structure embodying computer program code thereon for execution by a computer processor with said computer program code characterized in that it includes instructions for performing the steps of the method of claim 1 indicated as being performed by any component or a combination of components of said printing system or said mobile device or both said printing system and said mobile device.

21. A printing system for wireless printing of a file sent to a mobile device, comprising:
means for receiving information containing said file, optionally a location of said mobile device and optionally a minimum required security level for said remote printing from said mobile device by a wireless mechanism;
means for determining a remote printer closest to said location of said mobile device, said remote printer is capable of printing said file and also capable of providing said minimum required security level if said minimum required security level is provided, wherein said location is determined by said printing system based on said information if said information does not contain said location; and
means for printing said file on said remote printer by said printing system, wherein said remote printer is one of M remote printers capable of said remote printing by said printing system and M is an integer of at least a value of one.

22. The printing system of claim 21, wherein said minimum required security level is determined by said printing system based on said information if said information does not contain said minimum required security level.

23. The printing system of claim 21, wherein said information is provided by said mobile device requesting said remote printing.

24. The printing system of claim 21, wherein said location is added manually by a user of said mobile device requesting said remote printing.

25. The printing system of claim 21, wherein said means for determining a remote printer closest to said location of said mobile device contains a printer location database.

26. The printing system of claim 25, wherein said printer location database contains printer specific capabilities, printer locations and printer security levels regarding said M remote printers.

27. The printing system of claim 21, wherein said printing system further comprises a file storage area, for storing said file provided to said printing system.

28. The printing system of claim 21, wherein, before said printing by said means for printing said file on said remote printer, said file from the file storage area is provided to an appropriate application directory which opens said file and sends it to said remote printer for said printing, wherein said appropriate application directory is one of N application directories contained in said printing system, wherein N is an integer of at least a value of one.

29. The printing system of claim 21, wherein, after said printing by said means for printing said file on said remote printer, said remote printer sends to said printing system a print status signal indicating a success or a failure of said printing and said printing system forwards said print status signal and a printer location of said remote printer to said mobile device.

30. The printing system of claim 21, wherein said file is provided to said remote printer for said printing by said printer system using a wireless communication.

31. The printing system of claim 21, wherein said printing system is a server or a network element of a wireless communication system, or said printing system is a printing service hosted by a system operator.

32. The printing system of claim 21, wherein said information is provided by sending or forwarding from a remotely located inbox to said means for receiving of said printing system by said mobile device a message signal containing said file for said remote printing, optionally containing said location of said mobile device and optionally containing said minimum required security level.

33. The printing system of claim 21, wherein, if said location of said mobile device or said minimum required security level is not contained in said message signal, said means for receiving of said printing system sends to said mobile device in response to said message signal a location/security request signal requesting said location of said mobile device if said location of said mobile device is not contained in said message signal, and requesting said minimum required security level if said minimum required security level is not contained in said message signal, and, in response to said location/security request signal, said mobile device sends to said means for receiving of said printing system a location/security signal containing said location of said mobile device if requested by said location/security request signal and optionally containing said minimum required security level if requested by said location/security request signal.

34. The printing system of claim 33, wherein said means for receiving of said printing system is a communication block of the printing system.

35. The printing system of claim 34, wherein, using said information received by the information block, said communication block sends a file signal containing said file to a file storage area of said printing system and sends a print information signal containing said location of said mobile device, a type of said file, an ID of said file and optionally said minimum required security level to a print operator of said printing system.

36. The printing system of claim 35, wherein said means for determining a remote printer contain said print operator, responsive to said print information signal and a printer location database of said printing system communicating with said print operator, wherein said printer location database contains printer specific capabilities, printer locations and printer security levels regarding said M remote printers.

37. The printing system of claim 36, wherein said print operator provides to an appropriate application directory, which is capable of opening said file, a print request signal containing said ID of said file and an address of said remote printer, wherein said appropriate application directory takes said file from the file storage area, opens said file and sends said file to said remote printer for said printing, wherein said appropriate application directory is one of the N application directories contained in said printing system, wherein N is an integer of at least a value of one.

38. The printing system of claim 37, wherein after said printing, said remote printer sends to said print operator a print status signal indicating a success or a failure of said printing and said print operator forwards said print status signal and a printer location of said remote printer to said mobile device.

39. The printing system of claim 21, wherein said mobile device is a wireless electronic device, a mobile communication device or a mobile phone.

40. A wireless system for remote printing a file, comprising:
at least one mobile device to which said file is sent, for providing by a wireless mechanism information containing said file, optionally a location of said at least one mobile device and optionally a minimum required security level for said remote printing;
a printing system, responsive to said information sent by said wireless mechanism, for determining a remote printer closest to said location of said at least one mobile device, said remote printer is capable of printing said file and also capable of providing said minimum required security level if said minimum required security level is provided to said printing system, wherein said location is determined by said printing system based on said information if said information does not contain said location; and
M remote printers, capable of said remote printing by said printing system, wherein said remote printer is one of said M remote printers and M is an integer of at least a value of one.

41. The wireless system of claim 40, wherein said minimum required security level is determined by said printing system based on said information if the information does not contain the minimum required security level.

42. The wireless system of claim 40, wherein said information is provided by said mobile device requesting said remote printing.

43. The wireless system of claim 40, wherein said location is added manually by a user of said mobile device requesting said remote printing.
